(19) United States
(12) Patent Application Publication
(10) Pub. No.: US 2009/0155592 A1
(43) Pub. Date: Jun. 18, 2009

(54) POLYMER MACROPARTICLE OF WHICH SURFACE IS MODIFIED BY MESOPARTICLE AND NANOPARTICLE, NANOPARTICLE-POLYMER COMPOSITE USING THE SAME, AND PREPARATION THEREOF

(75) Inventors: Jung-Hoon Lee, Seoul (KR); Gilbae Choi, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: SILVIX CO., LTD, Suwon-Si, Kyunggi-do (KR)

(21) Appl. No.: 12/299,836

(22) PCT Filed: May 7, 2007
(86) PCT No.: PCT/KR07/02240

§ 371 Date: Nov. 6, 2008

(30) Foreign Application Priority Data
May 8, 2006 (KR) 10-2006-0041257

(51) Int. Cl. B32B 27/14; B05D 1/12; B01J 19/00

(52) U.S. Cl. 428/407; 427/201; 422/164

(57) ABSTRACT

According to the present invention, it is possible to easily provide a polymeric macroparticle of which surface is modified with mesoparticles and nanoparticles, by the step of adhering mesoparticles and nanoparticles to the surface of said polymeric macroparticle to form a composite structure of nanoparticle-mesoparticle-macroparticle, and optionally subjecting to a heat treatment to fix said mesoparticles and nanoparticles onto the surface of macroparticle. In addition, a nanoparticle-polymer composite materials can be provide from the above polymeric macroparticles of which surface is modified with mesoparticles and nanoparticles.

### TECHNICAL FIELD

The present invention relates to a polymeric macroparticle of which surface is modified with mesoparticles and nanoparticles, a nanoparticle-polymer composite material using the same, and the preparation thereof. More particularly, the present invention relates to a polymeric macroparticle to which mesoparticles and nanoparticles are adhered or attached to modify the surface, a nanoparticle-polymer composite material obtained by blending thus prepared polymeric macroparticles, and the preparation thereof.

### BACKGROUND ART

To this time, many researches have been proceeding in order to develop nanoparticle-polymer composites and their preparation methods.

Conventional systems wherein nanoparticles are incorporated and dispersed into a polymer matrix do not produce composite materials with satisfactory characteristics since there are the change of state of nanoparticles due to their high surface energy, the change of granularity of nanoparticles owing to their secondary coagulation or the like.

A system in which nanoparticle and monomer are mixed and polymerized proceeds two steps of the polymerization of monomers in the presence of nanoparticles and then the reduction of metal ions dispersed in the polymerized matrix [e.g. Polym. Composites, 1996, 7, 125; J. Appl. Polym. Sci., 1995, 55, 371; J. Appl. Polym. Sci., 1996, 60, 323]. However, this system accompanies problems that the metal nanoparticles are well not dispersed in the polymeric matrix since the polymerization and the reduction are separately preceded.

A system in which a nanoparticle precursor is mixed with a polymer and then a nanoparticle is prepared from the precursor [e.g., Chem. Commun., 1997, 1081; Korean Patent No. 10-0379250; Korean Patent Laid-Open No. 2330-0082064] forms nanoparticles in a polymer by reducing nanoparticle precursors by UV or gamma ray. However, the type of polymer to which this system can be applied is restricted since the nanoparticle precursors and polymer should be uniformly mixed.

Nanoparticles consisting of a transition metal such as gold (Au), silver (Ag), palladium (Pd), platinum (Pt) or the like are present as an agglomerated powdery form or has a tendency to be sensitive to the atmosphere and thus to irreversibly coagulate owing to their sensitivity to atmosphere. The irreversible coagulation of particles causes a phase separation by which the particle size distribution cannot be narrowed. Further, the coagulation obstructs the easy formation of a soft and thin film which is necessarily requested in the field of magnetic recording filed or the like. In addition, nanoparticles-coagulated particles diminish or restrict the chemically active surface area and the solubility for catalytic action.

Meanwhile, hitherto, for the purpose of the prevention of solidification or crystallization of solid particles, the prevention of change in color and quality, the improvement of dispersibility and flowability, the improvement of catalytic effect, the control of digestion and absorption, the improvement of magnetic characteristics, the improvement in color tone and lightfastness, the saving of useful (expensive) materials, and the like, various kinds of surface modification are performed by an electrochemical method, a physical adsorption method, a vacuum deposition method, an electrostatic adhering method, a method of coating soluble materials, a specific spray drying method, a flow coating method, etc. Among these methods, a mention can be made on a surface modification of solid particles with solid particles, for example, a surface modification of powdery particles with other powder, or a surface modification of solid particles with a suspension of microparticles of various materials, a solution or molten liquid of various materials. The above-described surface modifications can be carried out by employing a stirrer such as various mixer or ball mill to stir for a long time (several hours˜several ten hours), and accomplished on the basis of the electrostatic phenomenon, the slow dryness phenomenon or the mechanochemical phenomenon accompanied with the stirring. However, there have arisen problems that the adhesion of offspring-particle or film-forming materials to parent-particle is insufficient and that film is not uniformly formed on parent particles owing to unequal power onto the parent particles. Further and accordingly, in case of subjecting the modified powder to further step for processing such as mixing, blending, dispersing, making a paste or the like, there have arisen problems such as an easy remove of offspring particles and a segregation of ingredients, which significantly restrict the operation conditions of the next processing as well as may be an important reason for the quality difference between products obtained after the above processing.

For example, Korean Patent No. 90-001366 (corresponding to JP) discloses a method for fixing, on the surface of a macroparticle (parent-particle), other solid particles (offspring-particle) of which size are relatively smaller than the macroparticle (parent-particle) or a liquid-state material by employing a impulsive impact means. However, when nano-sized particles (offspring-particle) are adhered onto the surface of macroparticle (parent-particle), a considerable coagulation arises during the adhesion of nanoparticle onto the surface of macroparticle, and thus it is difficult to prepare a nanoparticle-polymer composite material wherein nanoparticles are dispersed without a considerable coagulation.

### DISCLOSURE

### Technical Problem

Therefore, the present inventors extensively studied the method of adhering nanoparticles onto the surface of polymeric macroparticles without a considerable coagulation of nanoparticles, and as a result, found that it is possible to prevent an excess coagulation of nanoparticle by restricting the size of macroparticles as well as increasing their surface, which can be accomplished by adhering, onto the surface of macroparticles, both of mesoparticles having a smaller size than the macroparticle and nanoparticles having a smaller size than the mesoparticle simultaneously, successively or alternatively by means of a mechanical means such as an impulsive impact means.

### Technical Solution

An object of the present invention is to provide a polymeric macroparticle of which surface is modified with mesoparticles and nanoparticles and its preparation, characterized by that mesoparticles and nanoparticles are fixed, adhered or attached onto the surface of a macroparticle to form a composite structure of nanoparticle-mesoparticle-macroparticle by employing a mechanical means such as an impulsive impacting means, a dynamic mixing means, and high speed blowing means.

Another object of the present invention is to provide a nanoparticle-polymer composite material by using thus prepared polymeric macroparticles of which surface is modified with mesoparticles and nanoparticles.

Another object of the present invention is to provide a device for preparing a polymeric macroparticle of which surface is modified with mesoparticles and nanoparticles and having a composite structure of nanoparticle-mesoparticle-macroparticle.

In below, the present invention is illustrated in more detail.

In the present invention, a polymer used as polymeric macroparticle can be selected from, but not limited to the group consisting of:
PE(Polyethylene)-based resins, for example, LDPE (Low density PE), LLDPE (Ultra low density PE), HDPE (High density PE), EVA (Ethyl Vinylacetate), and their copolymers;
PS(Polystyrene)-based resins, for example, HIPS, GPPS, SAN, etc;
PP(Polypropylene)-based resins, for example, Homo PP, Random PP, and their copolymers;
Transparent or general ABS (Acrylonitrile-Butadiene-Styrene terpolymer);
Hard PVC;
Engineering plastics, for example, a nylon, PRT, PET, POM (an acetal), PC, Urethane, Powdery resins, PMMA, PES, etc.

The pulverization of polymer particles can be carried on by using common mills.

In the present invention, the sizes of a macroparticle, a mesoparticle and a nanoparticle can be defined on the basis of an absolute scale as well as size ratios therebetween. Specifically, the macroparticle, mesoparticle and nanoparticle can have, on the basis of their mean particle size, a size ratio of 10:1˜200:1, particularly 20:1˜100:1 for macroparticle and mesoparticle, and a size ratio of 10:1˜200:1, particularly 20:1˜100:1 for mesoparticle and nanoparticle, which can be adjustable, if necessary. For example, when a polymeric macroparticle has a mean particle size of 200˜400 μm, a mesoparticle such as calcium carbonate or other polymer may have a mean particle size of 2˜10 μm, and silver nanoparticle can have a mean particle size of 40˜200 nm.

In the present invention, the size of each particle can be selected from, but is not limited to, 100˜500 μm for a polymeric macroparticle, 1˜10 μm for a mesoparticle, and 5˜500 nm for a nanoparticle.

If the size ratios among a macroparticle, a mesoparticle and a nanoparticle are maintained, said particles can have a different size out of the size range defined as above. For example, if a nanoparticle has a size of approximately 5 nm or less, a mesoparticle can have a size of 100˜1000 nm.

Mesoparticle can be made with a material which is the same with or similar to that of macroparticle or mesoparticle. Specifically, it is possible to mention a polymer which is the same with or similar to macroparticle or a filler material for a polymer such as silica, titania, alumina, carbon carbonate, etc.

Nanoparticle is not specifically restricted, but can be prepared from metallic, inorganic, organic materials or a composite thereof, and a transition metal or gold and silver can be particularly mentioned.

Said mesoparticle and nanoparticle can be used in a powdery form as well as colloid solution form. In case of a colloid solution form, they can be coated on the surface of macroparticle by spraying or atomizing to form a micro-droplet form, for example.

In the present invention, the adhesion of mesoparticle or nanoparticle onto the surface of macroparticle can be accomplished by an electrostatic force between particles as well as by means of a mechanical means such as an impulsive impacting means, a dynamic mixing means or a high-speed blowing means. As to an impulsive impacting means, it is preferable to employ an impactive pulverizing device equipped with a cutter or the like rotating in a high speed. As an example of said impulsive impacting means, an apparatus disclosed in Korean Patent No. 1990-001366 or a commercial apparatus (e.g. HYBRI manufactured by Dongmyung Kikong in Korea) having functions similar to those described in said Korean Patent can be employed. In the impulsive impacting means, mesoparticles/nanoparticles are able to be laid or tightly fixed under or onto the surface of macroparticles since the impulsive impact is carried out many times repeatedly and successively within a short period (several seconds˜several minutes).

According to one embodiment of the present invention, a commercially available common polymer is introduced into an impulsive impact, and circulated and pulverized to polymeric macroparticles with a mean particle size of about 200 μm. Thus prepared macroparticles are circulated under heating, during which calcium carbonate particles with a mean particle size of about 2 μm and a colloid solution of silver nanoparticles with a mean particle size of about 20 nm are introduced by spraying or the like onto the macroparticle simultaneously, successively or alternatively, and then solvent is gradually removed. Thus resulted macroparticles treated with mesoparticles and nanoparticles are again introduced into the impulsive impact pulverizer and repeatedly subjected to the above pulverization, circulation and treatment with mesoparticles and nanoparticles, by which it is possible to pulverize any agglomerated macroparticles and to increase the amount of mesoparticles and nanoparticles to be coated on the macroparticles.

FIG. 1 is an illustrative view showing a shape of nanoparticle-mesoparticle-macroparticle composite materials prepared according to the present invention. The mesoparticles (2) attached on the macroparticle (1) increases the surface area, and the nanoparticles (3) are distributed on the surface of the macroparticle (1) and the mesoparticles (2).

FIG. 2 is an illustrative view showing a shape of composite materials having a multi-layered structure prepared according to the present invention. In the drawing, the nanoparticles (3) attached on the macroparticle (1) and the mesoparticles (2) are illustrated only within the right-top box. It shows that it is possible to form a multi-layered structure on the surface of macroparticle by spraying in several times mesoparticles and nanoparticles simultaneously or alternatively.

According to the method of the present invention, it is preferable that the conditions for the pulverization, the circulation and/or the operation are controlled so as to induce an electrostatic charge. If necessary, therefore, it is possible to employ a device for generating n electrostatic charge. Macroparticles with electrostatic charge induced on its surface can increase the adsorption of mesoparticles and nanoparticles as well as may increase the coagulation of macroparticles. However, the coagulated macroparticles will be broken out during repeated circulation in the impulsive impacting mixer or the like.

It is preferable to prepare mesoparticles used in the present invention with a materials the same with or similar to that of macroparticles or with a material which can help the binding between macroparticle and nanoparticle. In addition, mesoparticle and nanoparticle can be composed of a single material or multiple materials. By using a mixture comprising silver nanoparticles and other metallic or inorganic nanoparticles or a colloid solution of said mixture, the target nanoparticle to be dispersed without coagulation, for example, silver nanoparticles can avoid the formation of agglomerates composed of only silver nanoparticles.

According to one variant of the present invention, it is possible to mix mesoparticle and nanoparticle in advance and then to add the obtained mixture to the macroparticle. In such case, mesoparticles which have not been mixed with nanoparticles can be added to further prevent the coagulation of nanoparticles.

Meanwhile, according to one preferred variant of the present invention, macroparticle or mesoparticle can be used in solid or semi-solid form as well as they can be supplied in the form of liquid if the viscosity is sufficiently high. For example, mesoparticles having a fiber shape prepared by electrospinning can be present as highly viscose liquid when solvent is not removed and then present as semi-solid when solvent is removed but it is not yet sufficiently solidified.

According to one variant of the present invention, it is possible to employ another particle groups having a medium size between macroparticle and mesoparticle or between mesoparticle and nanoparticle. For example, it is possible to incorporate particles having a medium size into a particle size constitution to modify a particle size constitution consisting of macroparticle (mean size 0.1˜1 mm)-mesoparticle (mean size 110 gm)-nanoparticle (mean size 5˜50 nm) to a particle size constitution such as macroparticle (mean size 0.1˜1 mm)-semi-macroparticle (mean size 10˜50 μm)-mesoparticle (mean size 1˜10 μl)-semi-mesoparticle (mean size 100˜500 nm)-nanoparticle (mean size 5˜50 nm). In the similar manner, said medium particle can consist of two or more groups of particles with different sizes.

According to other embodiment of the present invention, a commercially available common polymer is pulverized to polymeric macroparticles with a mean particle size of about 200 μm. Thus prepared macroparticles are treated under heating in a mixing device such as a mixer to induce electrostatic charge thereon, to which mesoparticle such as calcium carbonate or titania with a mean particle size of about 2 μm in a form or powder or solution and a colloid solution or powder of silver nanoparticles with a mean particle size of about 20 nm are introduced by spraying or the like onto the macroparticles simultaneously, successively or alternatively, and then solvent is gradually removed. As to a mixing device, it is possible to employ a general mixer or kneader, but it is preferable to employ a dynamic mixing means such as a V-type mixer or a Cone-type mixer.

According to another embodiment of the present invention, macroparticle treated with mesoparticle and nanoparticle may be optionally heat-treated. The heat-treatment can make all or a part of mesoparticles and nanoparticles softened or molten and then fixed on the surface of macroparticles, and therefore, can prevent mesoparticles and nanoparticles from removed from the macroparticles during further impactive pulverization or circulation. In addition, the above heat-treatment can enable a macroparticles treated with mesoparticles and nanoparticles to form a thin film on their surface, by which it is possible to prepare a polymer particle having a multilayer structure.

According to another embodiment of the present invention, it is possible to employ ultrasonic wave or a sonicator in order to prevent a coagulation of nanoparticles on macroparticles and to break coagulated nanoparticles.

The other object of the present invention is to provide a device for performing the above-described method, comprising an impulsive impacting room equipped with an impulsive impact means, a main inlet for feeding macroparticles into said impulsive impacting room, a circulating road communicating an main outlet of the impacting room with said main inlet, a mesoparticle inlet and a nanoparticle inlet which are installed at the circulating road, and optionally an electrostatic-inducing means and a sonicator.

It is possible to prepare nanoparticle-polymer composite materials by blending thus obtained multilayered composite materials having nanoparticle-mesoparticle-macroparticle constitution.

According to a preferred method of the present invention, macroparticle is selected form polymeric particles, mesoparticle is selected form inorganic or organic particles, and nanoparticle is selected form inorganic or metallic particles. For example, macroparticle may be made from nylon 12, mesoparticle may be titania particle, and nanoparticle is a silver nanoparticle or a silica or titania containing silver, such as a silver-carried or silver-impregnated silica or titania particles.

The preparation of nanoparticle-polymer composite materials according to the present invention can be applied to other metallic particles, organic particles or inorganic particles.

### Advantageous Effects

According to the present invention, mesoparticle and nanoparticle are fixed, adhered or attached onto the surface of macroparticles by means of a mechanical means selected from an impulsive impacting mixing device, a dynamic mixing device, a high speed blowing device, to form a composite structure having nanoparticle-mesoparticle-macroparticle, and optionally to be subjected to a heat treatment to fix the mesoparticles and/or nanoparticles onto the surface of the macroparticles, by which it is possible to easily and conveniently prepare a polymeric macroparticle with surface modified with mesoparticles and nanoparticles. Further, by using thus prepared polymeric macroparticle with surface modified with mesoparticles and nanoparticles, it is possible to provide a nanoparticle-polymer composite material.

### DESCRIPTION OF DRAWINGS

FIG. 1 is an illustrative view showing a shape of nanoparticle-mesoparticle-macroparticle composite materials prepared according to the present invention,

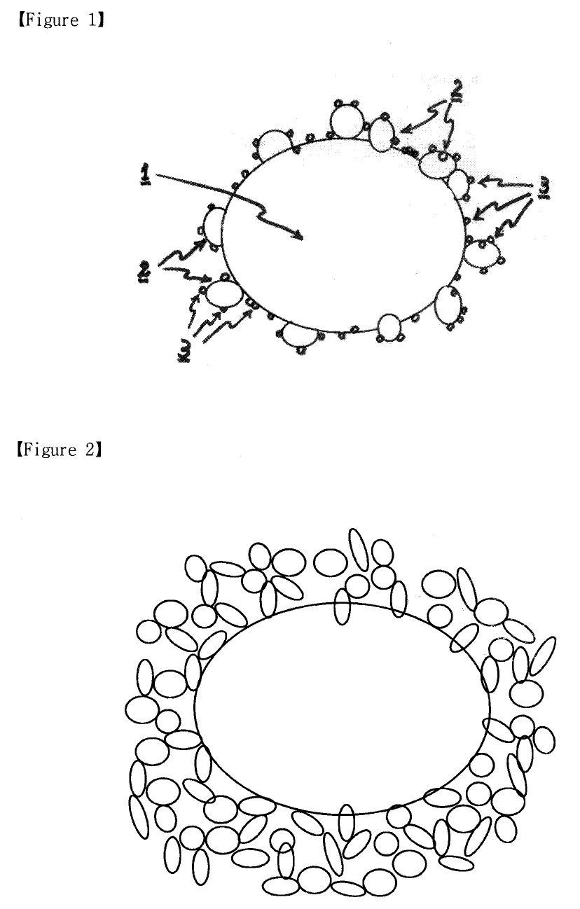

FIG. 2 is an illustrative view showing a shape of multi-layered composite materials prepared according to the present invention,

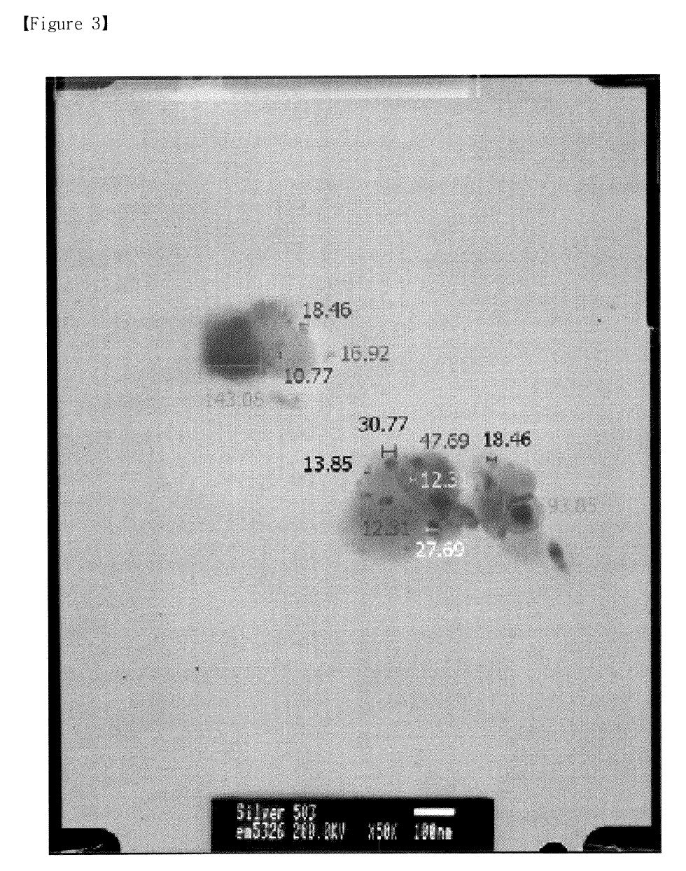

FIGS. 3 and 4 are TEM photographs (scale bar 100 nm) of an antibacterial PET composite resin prepared in Example 1 of the present invention,

FIG. 5 is a TEM photograph (scale bar 500 nm) of an antibacterial PET composite resin prepared in Example 2 of the present invention.

### MODE FOR INVENTION

The present invention is more specifically illustrated by reference to, but is not limited to the following working examples.

### Example 1

A commercial chip (5 kg) of polyethylene terephthalate (PET) was pulverized to a 25˜30 mash size at room temperature and introduced into an impeller-equipped V-mixer. The V-mixer was rotated at a speed of 180 rpm and the impeller equipped in the V-mixer was separately rotated in a speed of 1200 rpm. Into the V-mix, introduced was by small and small a mixture prepared by mixing an aqueous colloid solution (18 g) having a concentration of about 2000 ppm of silver nanoparticles (a mean particle size of 20˜30 nm) with titania (15 g) (a mean particle size of 150˜200 nm). The resultant mixture was dried and extruded at a temperature of abut 250° C. to obtain an antibacterial PET composite in a chip form.

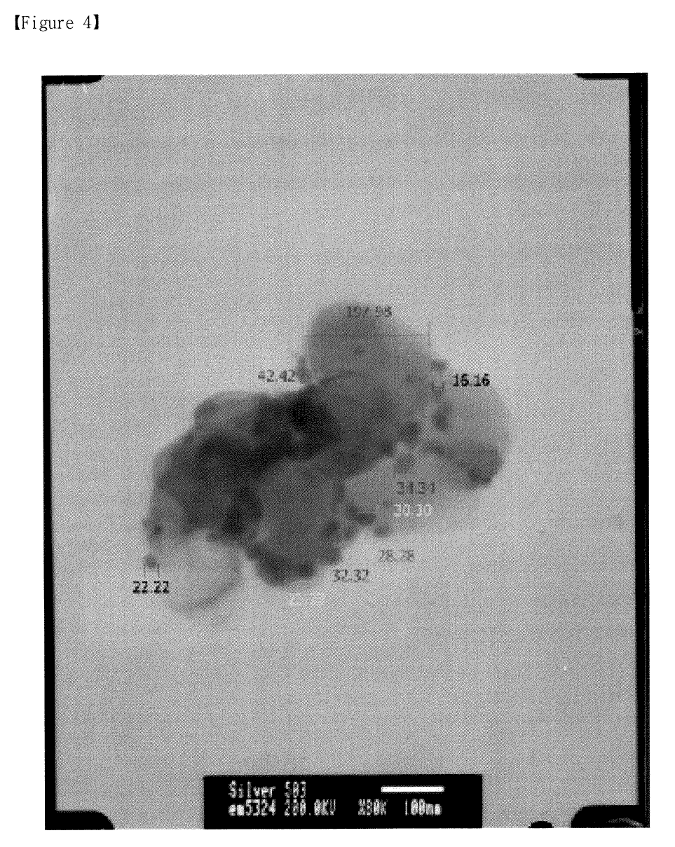

An analysis of thus obtained antibacterial PET composite by Transmission Electron Microscope (TEM) shows that silver nanoparticles and titania particles are uniformly dispersed without coagulation (See FIGS. 3 and 4, scale bar 100 nm). In FIGS. 3 and 4, it can be known that nanoparticles (that is, silver nanoparticles having a mean particle size of 20-30 nm) are distributed without coagulation on the surface of mesoparticles (that is, titania particle having a mean particle size of 150-200 nm) to form nanoparticle-mesoparticle composites particles, which are dispersed in the polymeric matrix.

### Example 2

A PET chip (5 kg) was pulverized to a 25˜30 mash size at room temperature and introduced into an impeller-equipped V-mixer. The V-mixer was rotated at a speed of 1800 rpm and the impeller equipped in the V-mixer was separately rotated in a speed of 1200 rpm. Into the V-mix, introduced were titania (15 g) (a mean particle size of 150˜200 nm) and then, by small and small, an aqueous colloid solution (18 g) having a concentration of about 2000 ppm of silver nanoparticles (a mean particle size of 20˜30 nm). The resultant mixture was dried and extruded at a temperature of abut 250° C. to obtain antibacterial PET composite in a chip form.

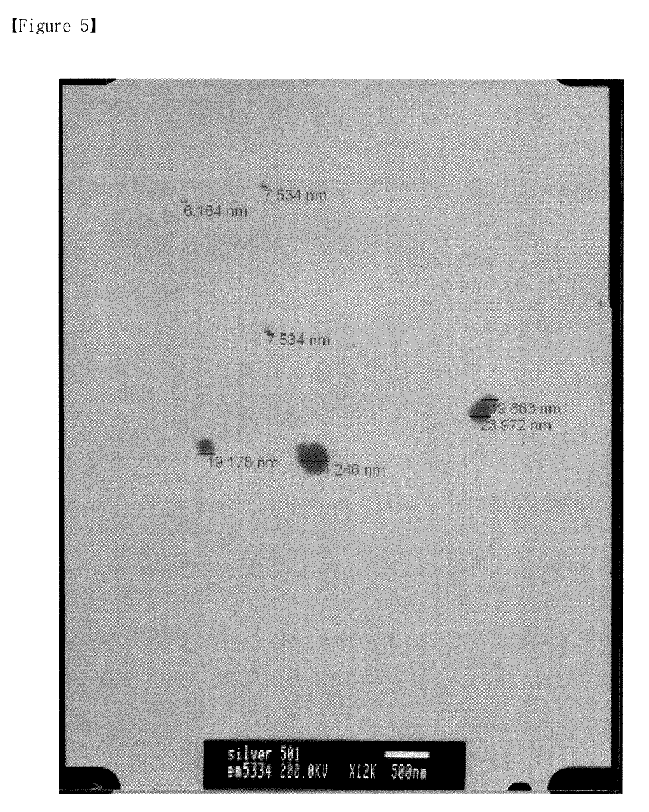

An analysis of thus obtained antibacterial PET composite by Transmission Electron Microscope (TEM) shows that silver nanoparticles and titania particles are uniformly dispersed without coagulation (See FIG. 5, scale bar 500 nm).

### Example 3

A polypropylene (PP) chip (4 kg) was pulverized to a 25˜30 mash size at room temperature and introduced into an impeller-equipped V-mixer. The V-mixer was rotated at a speed of 180 rpm and the impeller equipped in the V-mixer was separately rotated in a speed of 1200 rpm. Into the V-mix, introduced was by small and small a mixture prepared by mixing an aqueous colloid solution (2.1 g) having a concentration of about 20,000 ppm of silver nanoparticles (a mean particle size of about 4 nm) with silica (21 g) (a mean particle size of 100˜150 nm). The resultant mixture was dried and extruded at a temperature of abut 250° C. to obtain antibacterial PET composite in a chip form.

The present invention is not restricted to the above illustratively described embodiments and working Examples and can be modified or changed by a person having an ordinary technology pertinent to the art.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of the appended claims.

### INDUSTRIAL APPLICABILITY

According to the present invention, it is possible to provide a method for easily and conveniently preparing nanoparticle-polymer composite materials while preventing the formation of agglomerates between nanoparticles which is a problem in the existing process concerning composite materials.

1. A polymeric macroparticle of which surface is modified with mesoparticles and nanoparticles, wherein mesoparticles and nanoparticles are adhered or attached to the surface of said polymer macroparticle to form a composite structure of nanoparticle-mesoparticle-macroparticle.

2. The polymeric particle according to claim 1, wherein said mesoparticle is selected from a polymer particle or an inorganic particle, and said nanoparticle is selected from an inorganic particle or a metallic particle.

3. The polymeric particle according to claim 1, wherein said nanoparticle is selected form a sliver nanoparticle or a silver-containing inorganic particle.

4. A method of preparing a polymeric macroparticle of which surface is modified with mesoparticles and nanoparticles, which comprises the steps of adhering mesoparticles and nanoparticles to the surface of said polymeric macroparticle to form a composite structure of nanoparticle-mesoparticle-macroparticle, and optionally subjecting to a heat treatment to fix said mesoparticles and nanoparticles onto the surface of macroparticle.

5. A method of preparing a nanoparticle-polymer composite materials, which comprises the step of mixing and blending polymeric macroparticles with an optional polymer, wherein said polymeric macroparticles have been modified with mesoparticles and nanoparticles adhering mesoparticles and nanoparticles to the surface of said polymeric macroparticle to form a composite structure of nanoparticle-mesoparticle-macroparticle.

6. Nanoparticle-polymer composite materials prepared by a method according to claim 5.

7. A device for preparing a polymeric macroparticle of which surface is modified with mesoparticles and nanoparticles and having a composite structure of nanoparticle-mesoparticle-macroparticle, wherein said device comprises: an impulsive impacting room equipped with an impulsive impact means, a main inlet for feeding macroparticles into said impulsive impacting room, a circulating road communicating an main outlet of the impacting room with said main inlet, a mesoparticle inlet and a nanoparticle inlet which are installed at the circulating road, and optionally an electrostatic-inducing means and a sonicator.
